(19) United States
(12) Patent Application Publication
(10) Pub. No.: US 2024/0281408 A1
(43) Pub. Date: Aug. 22, 2024

(54) High Availability Storage using Overlapping Time Windows

(71) Applicant: Datadog, Inc., New York, NY (US)

(72) Inventors: Joshua Mason Gerth, Portland, OR (US); Dylan Shane Forciea, Edmond, OK (US)

(21) Appl. No.: 18/170,423

(22) Filed: Feb. 16, 2023

(51) Int. Cl. G06F 16/13; G06F 16/182

(52) U.S. Cl. CPC G06F 16/137; G06F 16/182

(57) ABSTRACT

Methods and systems are configured for receiving data associated with a data item, accessing first data structures, corresponding to a first time window, and comprising a first data structure that maps to first storage locations and a second data structure that maps to second storage locations. Second data structures corresponding to the second time window are accessed. The second data structures comprise a first data structure that maps to a set of storage locations that are absent the storage locations of the first storage locations and a second data structure that maps to a set of storage locations that are absent the storage locations of the second storage locations. Elements of each of the first data structures second data structures are identified. First and second storage locations are selected based on the elements.

### TECHNICAL FIELD

The disclosure relates to a data processing system that manages data storage in a data storage system. Specifically, this disclosure describes a data processing system that uses data structures associated with different time windows to distribute data across sets of data storage devices in a manner that ensures availability of data.

### BACKGROUND

Computer systems can be used to transmit, receive, and/or process data.

### DESCRIPTION OF DRAWINGS

FIG. 1 is a diagram of an example computing environment.

FIG. 2 is a diagram illustrating an example data processing system.

FIG. 3A is a diagram showing overlapping time windows.

FIG. 3B is a diagram showing overlapping time windows.

FIG. 4A is a diagram illustrating a data processing system that uses two or more data structures for determining storage locations of data items.

FIG. 4B is a diagram illustrating the data processing system of FIG. 4A for a second time window.

FIG. 5A is a diagram illustrating a data processing system that uses a data structure for determining storage locations of data items.

FIG. 5B is a diagram illustrating the data processing system of FIG. 5A for a second time window.

FIG. 6A is a diagram illustrating a data processing system that uses a data structure for determining storage locations of data items.

FIG. 6B is a diagram illustrating the data processing system of FIG. 6A for a second time window.

FIG. 7 is a flow diagram illustrating an example process for distributing the storage of data across one or more data storage systems.

FIG. 8 is a diagram of an example computer system.

### DETAILED DESCRIPTION

This application describes technology for distributing data across one or more data storage systems. The data storage systems include a physical set of hardware for storing data. For example, the data storage system can include one or more database systems (e.g., relational or non-relational databases), file systems, other data storage systems, or a combination thereof. The data storage system can be configured for high availability and provide data redundancy and fault tolerance. An example can include a computing monitoring system in which individual computing systems generate data (e.g., telemetry data) describing how the computing systems are processing data. The computing systems can send the data to the data storage system for redundant storage.

A data processing system determines the storage locations where individual data items (e.g., of a stream of telemetry data) are stored in the data storage system. The data processing system is configured to distribute redundant copies of data items across different sets of physical hardware of the data storage system. The data processing system may also or alternatively select storage locations that cause the data items to be more evenly distributed across the available storage locations. In one example, the data processing system may be configured to select storage locations that minimize storage hot spots where there are a significantly greater number of data items being stored or accessed.

The data processing system can ensure that the redundantly stored data items are distributed throughout the data storage system such that, should one or more portions of the data storage system become unavailable (e.g., restarted or failed), at least one copy of each data item remains available.

The data processing system can use multiple data structures to determine which storage locations to use to store the data items. Each data structure can include a set of elements and an element (also called an entry or location) in the data structure can include data (such as a pointer). In one example, the data of the element of the data structure can indicate where in the data storage system the particular data item is being stored. The data structures can therefore be used to map data items to respective locations in the data storage system.

The data processing system identifies storage locations to store the data items based on time windows. A time window corresponds to a period of time and can be associated with a time window identifier. The time window identifier can uniquely identify the time window and distinguish the time window from other time windows. The data processing system associates data items that are generated, sent, received, or processed at a point in time during one or more time windows with those time windows.

The data processing system associates each time window with a corresponding set of data structures. For example, an earlier time window can be associated with a first set of data structures (e.g., a first set of hash rings) and a subsequent time window can be associated with a second set of data structures (e.g., a second set of hash rings). Each set of data structures can include multiple data structures and has at least a first data structure (e.g., first hash ring) and a second data structure (e.g., second hash ring). In one example, the first data structure of the first set and the first data structure of the second are associated with consecutive overlapping time windows and are configured to use different sets of storage locations (e.g., different storage hosts/devices). The different sets of storage locations can be mutually exclusive and have no storage locations in common (e.g., absent, without, free of a common storage location). The mutual exclusivity can extend to all similarly positioned data structures in the sets (e.g., second data structure of both the first and second sets are mutually exclusive). This can further extend to sets of data structures for any adjacent overlapping time windows (e.g., second data structure of second set is mutually exclusive of the second data structure of both the prior and subsequent time windows).

The storage locations discussed above can be hosted on a pool of physical storage devices. Each of the physical storage devices (e.g., storage hosts) can include one or more of the storage locations. The pool of physical storage devices may fail or require updates, modifications, or other changes that cause the physical storage device to become unavailable. For example, the hardware or software of the pool of physical storage devices may need to be updated and it may require each of the physical storage devices to be restarted. The technology disclosed herein can enable the data processing system to restart the pool of storage devices in a more efficient manner that ensures that the stored data items remain accessible. For example, the restarting can include restarting all of the storage hosts that are associated with a first data structure of the first time window. When all of the storage hosts that are associated with the first data structure are available, the data processing system can restart all of the storage hosts that are associated with the second data structure of the first set of data structures. Because of the mutual exclusivity, the data items stored at storage locations affected by a restart will be accessible using the data structures of one of the adjacent overlapping time windows.

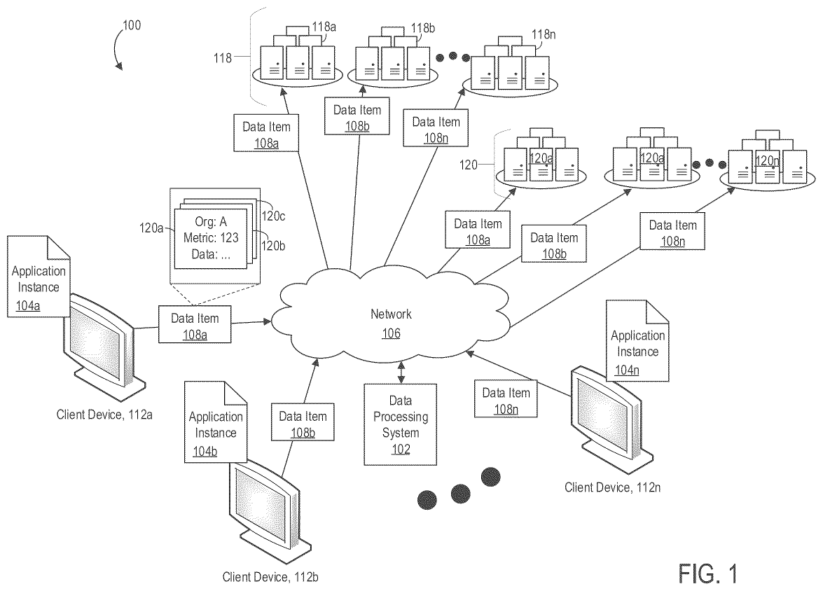

FIG. 1 is a diagram of an example computing environment 100 configured for distributing data across one or more data storage systems. The computing environment 100 includes one or more client devices 112a-n that are connected through a network 106 to a data storage system including data storage system sets 118, 120. Data storage system set 118 includes one or more portions 118a-n and data storage system set 120 includes one or more portions 120a-n. Each of the portions 118a-n and 120a-n can also be referred to as a storage host or storage device. The portions 118a-n, 120a-n are configured to store data items 108a-n (collectively data items 108) at locations in the data storage system (e.g., storage locations).

A storage location can correspond to a persistent storage location, non-persistent storage location, other storage location, or a combination thereof. Each set 118, 120 of hosts of the data storage system can includes one or more portions of a file system (e.g., volumes, partitions, directories, files), portions of a database (e.g., shards, tables, records), portions of other data storage system (e.g., blobs), or a combination thereof.

The client devices 112a-n (collectively client devices 112) include networked computing devices that perform computing operations. The client devices 112 can be related to a high-scale computing network. The client devices 112 are associated with a respective data processing system that monitors how the client devices 112 are operating.

The data processing system 102 is configured to manage where the data items 108a-n are stored in the data storage system. The data processing system 102 provides redundant storage of data items 108a-n and ensures that redundant copies are distributed across different portions 118, 120a-n of the data storage system in an approximately equivalent distribution. The data processing system 102 ensures that the data items 108 are distributed such that a set of the locations 118a-n of a set 118 can be restarted simultaneously without risk of the stored data becoming unavailable, as subsequently described. Each data storage system set 118, 120 includes locations associated with a time window, and the data items 108a-n are stored by each data storage system set 118, 120.

In an aspect, one or more of the client devices 112a-n can execute the logic for the data processing system 102 such that there are a plurality of instances of the data processing system 102. In an aspect, the data processing system 102 can be hosted in one or more other devices independent of the client devices 112. In an aspect, there are a different number of instances of the data processing system 102 with respect to the number of client devices 112.

The client devices 112a-n are each configured to execute respective application instances 104a-n. The application instances 104a-n can be software programs that are configured to perform any computing purpose for the data processing system 102. For example, client devices 112a-n, by the application instances 104a-n, can be configured to host websites, cloud computing functionality, or any such purpose. The application instances 104a-n can be identical or different from one another. The client devices 112a-n can operate independently from one another or can operate together and send data to and from one another over the network 106.

The one or more client systems 112a-n are distributed over a computing network 106, each executing one or more instances 104a-n of the application 104. The data processing system 102 is configured to communicate with the client systems 112a-n on the network 106. The data processing system 102 is configured to monitor how the application instances 104a-n are executing by tracking execution events (e.g., exceptions, queries, or other performance metrics) that are generated by the client devices 112a-n and reported to the data processing system 102 over the network 106.

The data processing system 102 is configured to receive identifying data associated with the data items 108a-n from the client devices 112a-n. The identifying data represents data items 108 and can include one or more key values. For example, the identifying data can include an organization name, performance metric identifier, log type, or other such metadata describing the data item. The data processing system 102 receives the identifying data and processes the identifying data to determine a location 118a-n, 120a-n for storing the data items 108a-n.

The data items 108a-n are generated by the one or more client devices 112a-n and represent how a particular client device or set of client devices is running. In one example, data items 108a-n can represent or describe respective application instances 104a-n during execution and can be reported in real time (e.g., when generated) to data processing system 102. In an aspect, a given data item 108a can include telemetry data that includes one or more of metric data (e.g., CPU utilization, memory consumption), log data (e.g., system events), trace data (e.g., resource consumption by function call), other data, or a combination thereof. The trace data may correspond to one or more spans of a trace. The trace may include a collection of operations that represent a unique transaction handled by an application and its constituent services. Each span may represent a single operation within the trace. Other information can be included in the data items 108.

The data processing system 102 can be part of a monitoring system. The client devices 112a-n generate data items 108a-n that represent how the client devices 112a-n are operating, such as how many queries are being processed, bandwidth usage, latencies of responses to queries, and so forth. The data processing system 102 processes the data items 108 to determine how the client devices are performing. In an example, the data processing system 102 generate alerts in response to detection of faults in the computing environment 100.

The monitoring system is configured to monitor how client devices 112a-n are operating at a high scale. For example, there can be hundreds, thousands, tens of thousands, or millions of monitored operations for the client devices 112a-n by the monitoring system. As such, even a small optimization (e.g., a reduction in processing time or bandwidth usage) by the monitoring system for monitoring a single operation results in a comparatively large reduction in consumption of computing resources for the monitoring system at scale. Therefore, the monitoring system can overcome practical limitations in available bandwidth overhead in the high-scale computing environment 100 by optimizing monitoring of individual operations.

In an aspect, a reporting module is configured to generate reports by querying the data items 108a-n from the data storage system. The type of report generated can be specified by a user or another computing system depending on how the data items 108 are being used. For example, output data generated by the reporting module can include a histogram of which exceptions were generated along with their types and counts for each type. In other examples, subsequently described, visualizations such as line graphs, tables, or other outputs are generated. These can be continuously or intermittently updated as sampling continuous on an ongoing basis along with reporting.

In an aspect, the data processing system output data can be stored in an output data store and used for one or more other purposes. For example, the results can be sent to a monitoring dashboard in real time or near real time. Here, real time includes a processing of data as its received and immediate output of that data without delaying, in which any latency is generally caused by the processing of the data (rather than internally storing any data for batch processing). Real time or near real time indicators can show how many exceptions are being generated per second and their types. Various alerts, alarms, etc. can be set for triggering in response to particular results of the profile data. For example, particular exceptions exceeding given threshold values can cause alarms or alerts to be generated and sent to an operator of the networked computing system. Other similar reporting applications are possible.

As described previously, the data processing system 102 is communicatively connected to the client devices 112a-n through the network 106. The data processing system 102 can include, but is not limited to, e.g., one or more server computers. The data processing system 102 can be configured to transmit, receive, and/or process data. In some cases, the data processing system 102 can be owned, operated, and/or maintained by parties different from those that own, operate, and/or maintain the client devices 112.

Each of the client devices 112a-n can include a respective user interface. Users can interact with the user interface to view content of the application instances 104a-n. Users can also interact with the user interface to transmit data to other devices (e.g., to the data processing system 102). Users can interact with the user interface to issue commands (e.g., to the data processing system 102). In an aspect, a user can install a software application onto client devices 112a-n in order to facilitate performance of these tasks.

The client devices 112a-n can include any electronic device that is used by a user to view, process, transmit and receive data. Examples of the client devices 112a-n include computers (such as desktop computers, notebook computers, server systems, etc.), mobile computing devices (such as cellular phones, smartphones, tablets, personal data assistants, notebook computers with networking capability), and other computing devices capable of transmitting and receiving data from the network 106. The client devices 112a-n can include devices that operate using one or more operating system (e.g., Microsoft® Windows®, Apple® MacOS, Linux, Unix, Android®, Apple iOS®, etc.) and/or hardware architectures (e.g., x86, ARM®, PowerPC® etc.) In an aspect, the client devices 112a-n need not be located locally with respect to the rest of the environment 100, and can be located in one or more remote physical locations.

The network 106 can be any communications network through which data can be transferred and shared. For example, the network 106 can be a local area network (LAN) or a wide-area network (WAN), such as the Internet. The network 106 can be implemented using various networking interfaces, for instance wireless networking interfaces (such as Wi-Fi, Bluetooth, or infrared) or wired networking interfaces (such as Ethernet or serial connection). The network 106 also can include combinations of more than one network, and can be implemented using one or more networking interfaces.

The data processing system 102 is illustrated as a respective single component. However, in practice, each can be implemented on one or more computing devices. In an aspect, the data processing system 102 can include multiple computing devices that are connected to the network 106. The data processing system 102 can alternatively be a single computing device that is connected to the network 106. In an aspect, the data processing system 102 need not be located locally to the rest of the environment 100, and portions of the data processing system 102 can be located in one or more remote physical locations from the client devices 112a-n.

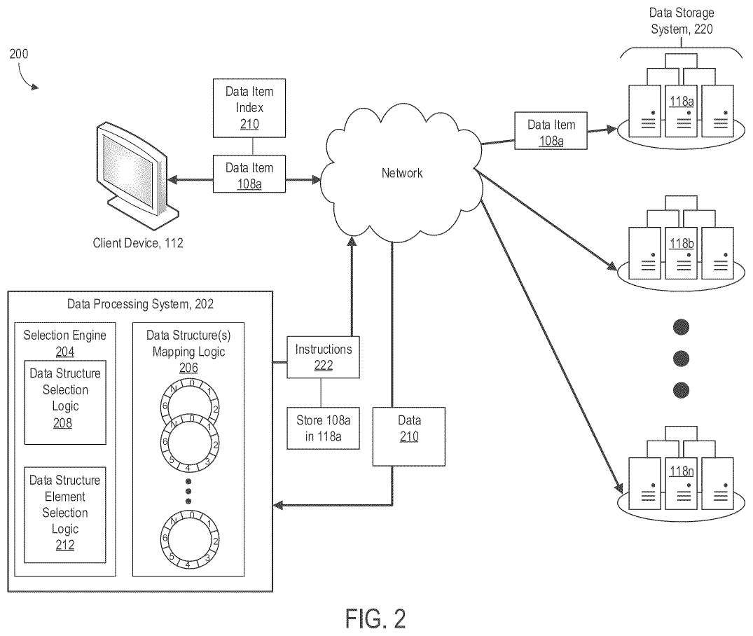

FIG. 2 is a diagram illustrating a computing environment 200 including an example data processing system 202 for distributing the storage of data in a data storage system 220. The data processing system 202 can include the data processing system 102 described previously in relation to FIG. 1. The data processing system 202 is configured to determine that a data item 108a is to be stored for the client device 112. The data processing system 202 determines a location (e.g., 118a) in data storage system 220 that data item 108a can be stored. The data processing system 202 can also cause data item 108a to be stored at the determined location in data storage system 220.

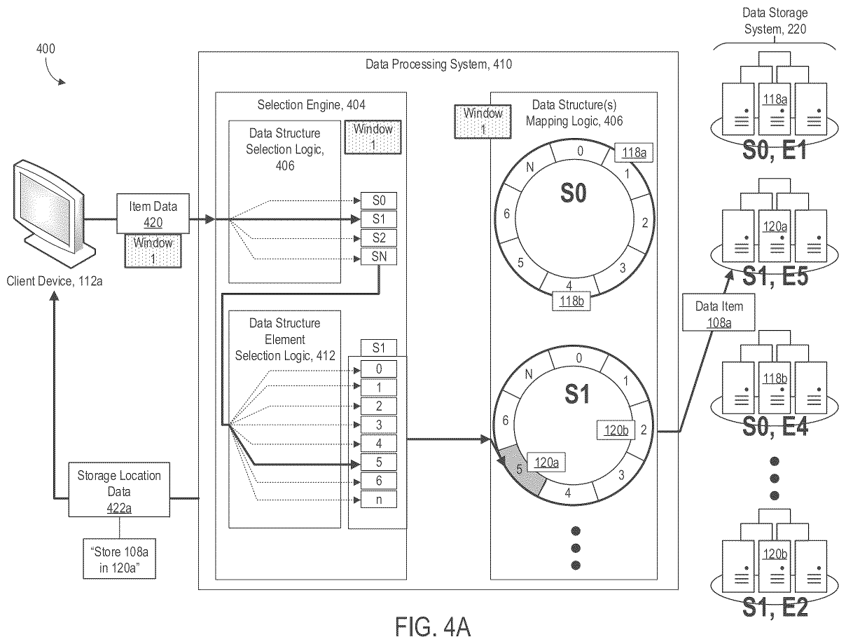

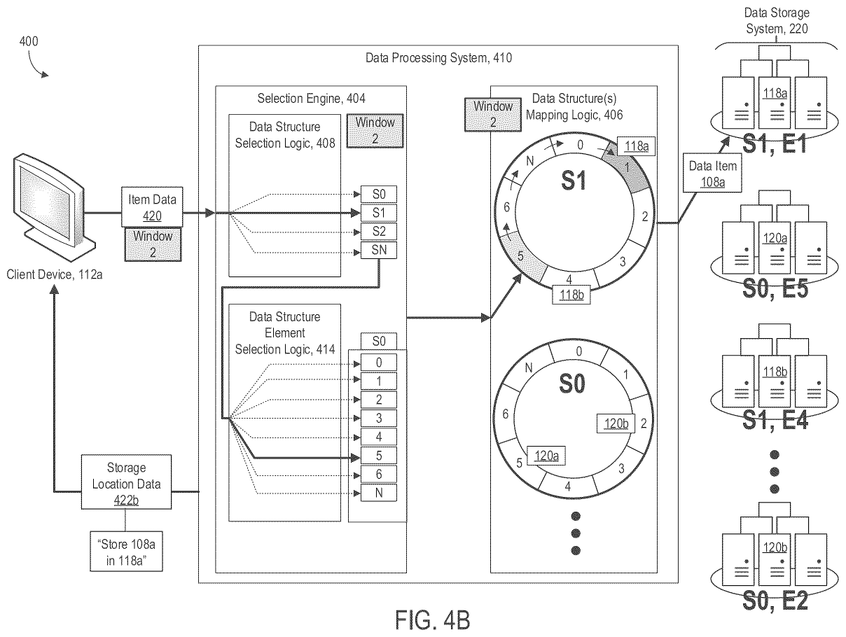

The data processing system 202 receives data 210 associated with the data item 108a that describes the data item. Here, data item 108a represents any one of data items 108a-n of FIG. 1. Generally, the data processing system 202 does not need to receive the data item 108a itself. Rather, the data processing system 202 can receive data associated with data item 108a to determine a storage location for data item 108a. The data associated with the data item 108a can include data internal to the data item (e.g., value of the data item) or data external to the data item (e.g., metadata), other data, or a combination thereof. The data associated with the data item can include organization data (e.g., Org ID), environment data (e.g., indicator of production or test environment), type data (e.g., type name, metric name), tag data (e.g., metadata added or included with data item), time data (e.g., time stamp), sequence data (e.g., sequence identifier), machine data (e.g., host name), application data (e.g., application identifier), index data, other data, or a combination thereof as discussed in more detail in regards to item data 420 of FIG. 4.

Data processing system 202 can determine a location for storing data item 108a based on the data associated with data item 108a. For example, data processing system 202 can receive data that identifies an organization that is associated with data item 108a and use that data to select one or more storage locations in data storage system 220 to store data item 108a. Data processing system 202 can generate instructions 222 that indicate the selected storage locations for storing the data item 108. In one example, data processing system 202 sends the instructions 222 to a storage manager (e.g., database management system or service) or some other portion of data storage system 220, and the storage manager, stores data item 108a at the selected storage location (e.g., 118a).

The data processing system 202 includes a selection engine 204 and data structure(s) mapping logic 206. The data processing system 202 uses the selection engine to select an element of a data structure of the data processing data structure mapping logic 206. The selection engine 204 includes data structure selection logic 208 for selecting a particular data structure of the set of data structures of the data processing system 202. The selection engine 204 includes data structure element selection logic 212. The data structure element selection logic 212 is configured to select an element of the selected data structure. The selected element of the data structure includes data that points to a location in the data storage system 220 for storing the data item 108a. Each of the data structure selection logic 208 and the data structure element selection logic 212 are subsequently described in greater detail.

The data structure mapping logic 206 includes instances of one or more data structures that specify, for one or more elements of each data structure, a location 118a-n in the data storage system 220 to store a data item 108a. As subsequently described, the data structures each include one or more elements. The elements are each capable of including data (e.g., pointer) that specifies a location in the data storage system 220 for storing the data item 108a (e.g., 118a). In one example, a data structure can be an array of elements. In another example, the data structure can be a linked list of elements.

The elements of the data structures can be configured so that each element is adjacent to one or more other elements (e.g., neighboring elements) Generally, each element of a data structure can be adjacent (e.g., linked to) another element in the data structure. The first element and the last element can be adjacent to one another so that forward traversal and backward traversal of the elements wraps around in a loop. In one example, each data structure can be a ring (e.g., hash ring). Each data structure can be identical to the other data structures of a set of data structures, except that elements of a particular data structure point to storage locations (e.g., 118a-n) that are absent from the corresponding data structure of an overlapping time window.

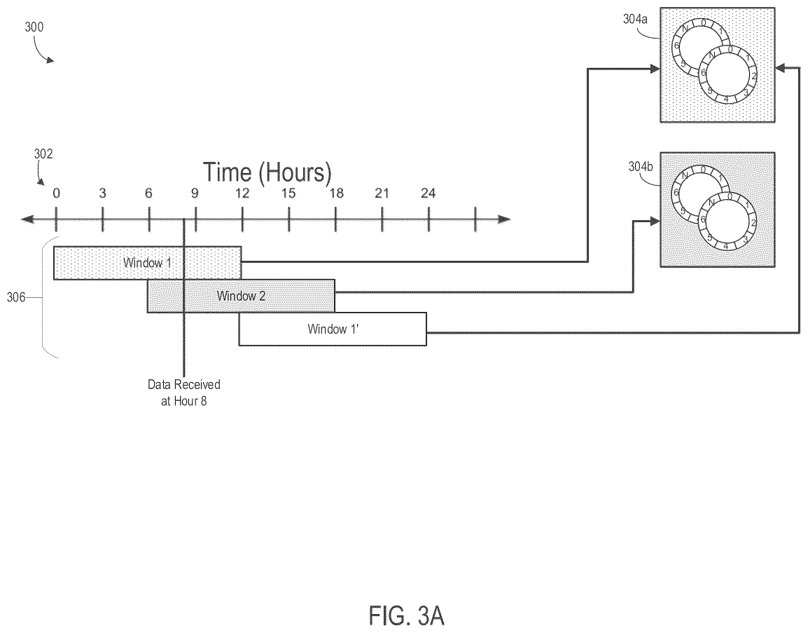

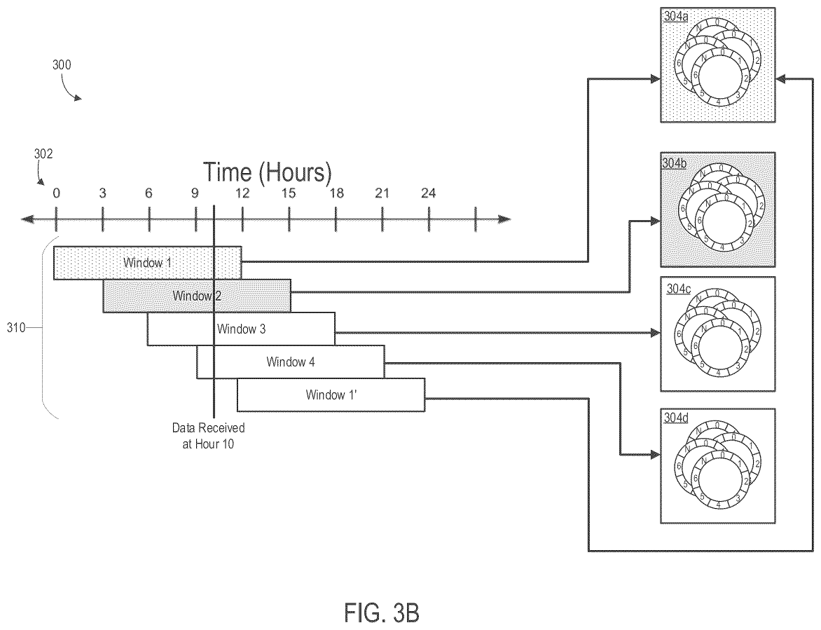

FIG. 3A is a diagram of a timeline 300 for generating data structures for the data processing system 202 of FIG. 2. The timeline 300 is divided into three-hour segments 302. The data processing system (e.g., data processing system 202 of FIG. 2) uses the segments 302 to define time windows 306. While 3-hour segments are shown in this example, any length of time can be used for defining the time windows 306.

The time windows 306 are overlapping time windows. A time window includes a length of time during which data items are stored. Each time window (e.g., time window 1, time window 2 . . . ) is associated with a set of data structures. For example, Window 1 is associated with set 304a and Window 2 is associated with set 304b. The data processing system 202 uses the set of data structures associated with a time window to map data items to storage locations in the data storage system. For example, when time Window 1 begins, a set of data structures 304a are generated for mapping the data items to storage locations of the data storage system. When the time window 1 expires, the set of data structures 304a can be stored, updated, replaced, removed, copied or a combination thereof. When time Window 2 begins, another set of data structures 304b are generated and used to map data items associated with time window 2 to storage locations of the data storage system. The set of data structures 304b can map the same exact data items to a different set of locations within the data storage system (e.g., to storage locations 120a-n instead of to storage locations 118a-n), as subsequently described.

Each set of data structures 304a-b are used to map a particular data item to different storage locations. This is because the storage locations associated with data structure 304a are mutually exclusive of the storage locations associated with data structure 304b. The set of locations associated with each data structure 304a-b, are associated with a particular time window and are used to store the data items for a configurable time period (e.g., 12 hours) until the window expires.

For any given point in time on timeline 300, there can be two or more windows that overlap. For example, at hour 8 time window 2 partially overlaps with time window 1. For a data item associated with hour 8 (e.g., data item generated or received at hour 8), the data processing system 202 provides two different locations for storing the data item, one location is determined using set 304a and another location is determined using set 304b. The data processing system 202 uses both sets 304a-b of data structures for mapping the data items while the time windows 1 and 2 are overlapping (e.g., during hours 6-12). For two overlapping time windows, the data redundancy is 2 but the redundancy can be more or less depending on the number of overlapping time windows.

The data processing system 202 can configure the length of the windows 306, the number of overlapping windows, and the number of data structures of each set 304a-b based on a given use case. For example, more than 2 windows can overlap as described in relation to FIG. 3B.

Additional data structures can be included in each of sets 304a-b. In one aspect, each of sets 304a-b can include a plurality of data structures. In another aspect, as subsequently described, each set of data structures 304a-b can be represented as a single data structure that is partitioned into sub-data structures (e.g., a single hash ring where even positions correspond to a first sub-data structure and odd positions correspond to a second sub-data structure).

Overlapping windows 306 are associated with a set of data structures 304a-b that are configured to store the same data items across different sets of storage locations. The data structures of each set 304a-b can distribute data items for an organization and key to different locations in the data storage system in an approximately equal manner for that organization and key. This is because data processing system 202 can ensure that the location (host) used to store a data item changes for each overlapping window. For overlapping, subsequent windows, the data processing system 202 maps the data items having the organization identifier and the shard identifier on two different sets of locations (hosts) that are exclusive to each other.

An example configuration of the sets of data structures 304a-b and the time windows 306 is now described. In an example, for each of the time windows 306, there is a corresponding set of data structures. For example, data processing system 202 associates Window 1 with set 304a and Window 2 with set 304b. Each of the sets includes a first data structure (e.g., first hash ring) and a second data structure (e.g., second hash ring).

FIG. 3B is a diagram showing a timeline 300 including overlapping time windows 310 and associated sets of data structures 304a-d. The time windows 310 are similar to the time windows 306 of FIG. 3A. In FIG. 3B, four time windows overlap at any particular instant in time, including time window 1, time window 2, time window 3, and time window 4 overlapping at the 10 hour point in time. When time window 1 expires, a new time window 1′ is defined (and the set of data structures 304a can be reused). Once the overlapping time windows 310 are defined, the data processing system 202 is configured for mapping data items to four mutually exclusive sets of locations in the data storage system. For example, at hour 10 the data processing system 202 can map, using four data structures of sets 304a-d, the same data item to a storage location in each of the four sets of locations. Examples of the mapping process are described in relation to FIGS. 4A-6B.

The data processing system 202, for the configuration of the time windows 310, defines a new set of locations in the data storage system (e.g., a database) every three hours. In an aspect, the time windows can be aligned to a UTC clock (e.g., new databases will be opened up at hours 0, 3, 6, 9 . . . ). By aligning the windows to the UTC clock, the data processing system need not track the open files in a centralized single-point-of-failure metadata database. In this example, each set of locations (database) is opened for a period of 12 hours. After 12 hours, the time window expires and the database may stop getting updated (e.g., closed and removed). As a result, each storage system has four open sets of locations (databases) at all times after an initial ramp up to hour 9. In an example, each storage system subscribes to a memory bus (e.g., a Kafka topic) for new data items (e.g., events). For each new data item (e.g., event A), the data processing system 202 determines a hash and checks a data structure (e.g., a consistent hash ring) to determine the storage location. If a storage location is found, the data processing system 202 causes the data item to be written to the location (e.g., in a location in the database). Each data item is written into four sets of locations (e.g., four database locations), and the locations are spread throughout the data storage system (cluster) and each opened at a different three hour increment. Clients can query specific sets of locations, which are identified by the hour they were opened.

The data processing system 202 can add additional sets of locations (e.g., databases) to the data storage system (cluster) at any time. The data processing system backfills the data for these added sets from existing stored data items before receiving queries. The data items stored in the added set can be found by determining a set of locations and a window in the data structures (e.g., a consistent hash ring) and walking backwards until the same window is found on a different location (host). Each index that the data processing system walks over is saved. The list of indexes is used to find the data items for that set of locations (e.g., in S3) because, as mentioned, the data items themselves are prefixed with the index.

Similarly, the data processing system can remove sets of locations (databases) from the data storage system (cluster) at any time. The impacted sets of locations that are in the data storage system are backfilled for the data which was being handled by the locations (hosts) that are being removed. The data processing system can automate the add/remove processes and new server hosts can be added and removed from the cluster.

Because the data processing system 202 maps the data items using four time windows 310 there is a replication factor of four in the data storage system for all data items. Because queries are only executed against a single window, older windows have more historical data in them than newer windows. Because most data are deduplicated before being sent to the sets of locations, the windows which have been opened for longer than the deduplication size are capable of being responsive to queries.

In an aspect, the data processing system 202 ensures that the data structures (e.g., hash rings) being built for each set 304a-d of the locations for the data storage system are identical to other sets. In this case, the data structures are the source of truth for determining which locations (hosts) are in the data storage system (cluster) and what time windows are currently being served.

In an aspect, the data processing system 202 executes a state service that periodically snapshots the data storage system to determine all locations (server hosts) in the data storage system. This list of locations is then periodically downloaded to the data processing system (or to its multiple instances) which enables the data processing system to build an identical data structures for each set of locations. The snapshot can either be taken from a heartbeat of each host in the data storage system, or the data processing system can query a directory to find a list of active hosts.

FIGS. 4A and 4B are diagrams illustrating a computing environment 400 including a data processing system 410 for distributing data in a data storage system 220. FIG. 4A illustrates how data processing system 410 determines a first location to store a data item using a set of data structures associated with a first time window. FIG. 4B illustrates the determination of a second location to store the same data item using a set of data structures associated with a second time window. The data processing system 410 can be similar to the data processing systems 102, 202 previously described in relation to FIGS. 1-3B.

In the example of FIG. 4A, the data processing system 410 is configured to receive item data 420 associated with a data item. The data processing system 410 is configured to determine where in a data storage system 220 to store the data item 108a based on the item data 420 and the current time window. The data processing system 410 generates storage location data 422a that indicates a location (e.g., location 120a) in the data storage system 220 for storing the data item 108a. In an aspect, the data processing system 410 is a part of the data storage system 220, and is hosted by devices that provide one or more (or each) of the locations 118a-b, 120a-b. In another aspect, the data processing system 410 can be hosted by another device that is separate from the client device 112a and data storage system 220 (e.g., separate hosted service).

The data processing system 410 includes selection engine 404 for selecting a particular element of a particular data structure for mapping the data item 108a to a location in the data storage system 220. The data processing system 202 includes data structures mapping logic 406. The mapping logic 406 includes the data structures S0, S1 which each have a series of elements 0. . . . N. The element selected by the selection engine 404 is accessed to determine the location in the data storage system 220 for storing the data item (e.g., 120a).

The data processing system 410 uses the item data 420 and the current active window(s) to determine locations to store the data item. The item data 420 may include any data associated with the data item, which may include data internal to data item 108a or data external to data item 108a. The data internal to the data item (e.g., internal data) may include values of the data item (e.g., metric data, log data, trace data). The data external to the data item (e.g., external data) may include metadata associated with the data item. In one example, item data 420 can include organization data (e.g., organizational identifier), source data (e.g., host identifier, service identifier, environment identifier), destination data (e.g., shard identifier), type data (e.g., metrics, logs, traces), time window data (e.g., time stamp for generation, receipt, or processing), other data, or a combination thereof.

Item data 420 can be hashed to identify an element in one of the data structures. Item data 420 may be hashed individually or in combination using one or more hash functions. The one or more hash functions can receive data as input and generate one or more hash values (e.g., digests). The one or more hash values can be used to determine a storage location in the data storage system 220, as subsequently described.

In the example of FIG. 4A, the data processing system 410 includes two data structures, S0 is the first data structure and S1 is the second data structure. The two data structures S0, S1 correspond to the set of data structures 304a shown in FIG. 3A. The number of data structures may depend on the number of overlapping time windows or may be independent on the number of overlapping time windows. For the configuration of time windows 310 of FIG. 3B, four data structures S0, S1, S2, and S3 can be used in a data processing system. In an aspect, a greater number of data structures S0, S1, S2, . . . . SN can be used. This ability to scale up is shown by ellipses in the data structures mapping logic 406.

Data processing system 410 receives item data 420 and determines the one or more active time windows (e.g., the currently running time windows). Data processing system 410 may determine the active time window to use based on the item data 420, system time, other data, or a combination thereof. The active time window may indicate the set of data structures to use and the item data 420 may be used to determine which element of the set of data structures to use to determine a storage location. The process of determining the element may involve one or more steps and a first step may involve identifying which data structure in the set to use (e.g., S0 or S1) and a second step may involve identifying which element in the identified data structure to use. For example, data processing system 410 can select an element from the data structures as follows. For time window 1, the data structure selection logic 408 is applied to the item data 420. The data structure selection logic 408 can apply a mathematical operation (e.g., modulo operation) to a portion of item data 420 (e.g., organization identifier and shard identifier) to select one of the data structures in the set. In this example, data structure S1 is chosen. The mathematical operation can include (value of item data 420) mod(n), where “n” is the number of data structures in the set (e.g., orgID+shardID)% 2).

The data processing system 410 uses data structure element selection logic 412 to determine a particular element of the identified data structure. The selection logic 412 is shown as distinct from the data structures selection logic 408, but these can be executed together using the functions previously described. The logic 408, 412 are separated for illustrative purposes to show both the selection of a data structure and its element, which is unique for the index value 420 and time window value. In the example shown, the element 5 of data structure S1 is selected.

Once the element of a data structure is selected, the data processing system 410 executes data structure mapping logic 406 to determine a location for storing the data item in the data storage system 220. The logic 406 can include a process for analyzing a data structure, which may involve traversing a data structure to identify an element in the data structure that indicates an available storage location. In this example, the data structures S0, S1 are hash rings and the process for using them to identify storage locations can be referred to as consistent hashing. Each data structures S0, S1 is generated for the corresponding time window 1. The first hash ring S0 includes elements 0. . . . N. At least some of the elements are configured to point to a first set of locations 118 (118a-b).

The second hash ring S2 includes elements 0. . . . N. At least some of the elements of S1 point to a second set of locations 120 (e.g., 120a-b) of the data storage system 220.

The locations in the first set 118 are mutually exclusive from the locations in the second set 120. The storage locations 118a-n in set 118 are absent from the set of locations 120. Similarly, the storage locations 120a-n in set 120 are absent from the set of locations 118. In this example, the data storage system 220 is divided into two sets 118, 120 of locations. The mutual exclusivity of sets of locations can be scaled up to include additional sets in the data storage system. Additional data structures S3 . . . SN can be added, one for each set of locations. As previously described, the number of overlapping time windows also increases to match the number of sets of mutually exclusive locations in the data storage system 220.

In this example, element 5 is identified by data structure element selection logic 412 and becomes input for logic 406. Logic 406 uses element 5 as a starting point and checks whether element 5 of data structure S1 includes an available storage location. In this example, data structure S1 is associated with locations from the set 120 of locations in data storage system 220 and element 5 of data structure S1 includes content indicating storage location 120a. The data processing system 410 generates storage location data 422a based on the contents of element 5 (e.g., pointer for location 120a) and provides storage location data 422a to an entity that will store data item 108a. The data item 108a can then be stored at storage location 120a (e.g., storage host 120a).

FIG. 4B is a diagram illustrating the data processing system 410 for distributing data in the data storage system using at least two data structures for a second time window (time window 2). The data processing system 410 determines a location for storing the data item 108a for the second time window (time window 2). As previously described, the time window 2 can overlap with time window 1 of FIG. 4A, and so the data item 108a is stored in a first location (e.g., 120a) for time window 1 and a second location (e.g., location 118a) for time window 2.

The data processing system 410 selects, using the data structure selection logic 408 and the data structure element selection logic 414, an element 5 of data structure S1. For time window 2, the data structures S0, S1 have swapped the sets of locations 118, 120. For time window 1, elements of data structure S0 points to locations 118a-b of set of locations 118. For time window 2, elements of data structure S0 point to locations 120a-b of set 120 of locations. The elements for data structure S0 at time window 2 point to a set of locations 118 that are absent from the set of locations 120 mapped by the data structure S0 at time window 1. Similarly, the elements for data structure S1 at time window 2 point to a set of locations 120 that are absent from the set of locations 118 mapped by the data structure S1 at time window 1.

The selection engine selects element 5 of data structure S1 for time window 2 for data item 108a. However, the data structure S1 is now different than the data structure S1 for time window 1, as previously discussed. Element 5 of the data structure S1 is now absent a storage location (e.g., empty, without, or free of content indicating an available storage location). The data processing system 410 traverses the hash ring S1 until an element is found that includes a storage location (e.g., occupied, non-empty element). In this case, element 1 is the next element that includes content that corresponds to an available storage location (e.g., points to location 118a). The data processing system 410 generates storage location data 422b based on the content of the element storage and provides the storage location data to one or more devices that will store data item 108a. Data item 108a is then stored at a location 118a (e.g., storage host 118a).

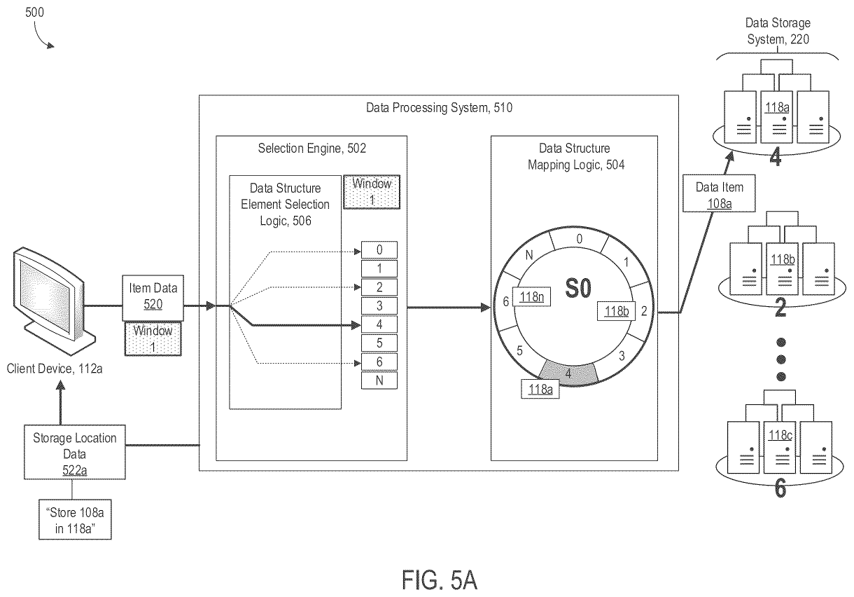

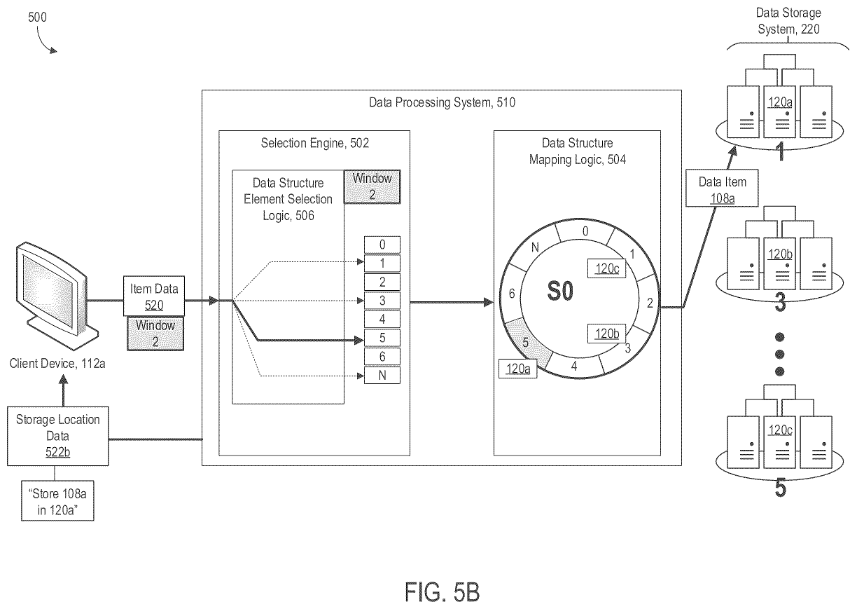

FIGS. 5A and 5B are diagrams illustrating a computing system 500 that uses a data structure that has sub-data structures (e.g., single ring with even elements representing a first sub-data structure and odd elements representing a second sub-data structure). FIG. 5A illustrates the determination of a first storage location for a data item using a data structure associated with a first time window and FIG. 5B illustrates the determination of a second storage location for the same data item using a data structure associated with a second time window. The computing system 500 can be similar to computing system 400, previously described in relation to FIGS. 4A-4B. The data processing system 510 includes a selection engine 502 configured to execute data structure element selection logic 506. The data processing system 510 includes data structure mapping logic 504.

In regards to FIG. 5A, selection logic 506 selects an element from the single data structure of the data structure mapping logic 504. The mapping logic 504 includes a single hash ring S0 (e.g., a single data structure) that is partitioned in to sub-data structures. Each of the sub-data structures of the hash ring S0 include elements that point to a set of locations that are absent from the set of locations of the other sub-data structures. In the example shown, the data structure S0 can be divided into odd elements 1, 3, 5 . . . N and even elements 0, 2, 4 . . . N. The even elements specify locations 118a-c of a first set 118 of locations of the data storage system 220. The odd elements specify locations 120a-c of a second set 120 of locations of the data storage system 220 (e.g., as seen in FIG. 5B). For each overlapping time window (e.g., time window 1 and time window 2 of FIG. 3A), the data processing system 510 can partition the data structure S0 into a corresponding number of sub-data structures, each sub-data structure being associated with a respective time window. In the example of FIGS. 5A-5B, the even elements of data structure S0 are associated with time window 1, and the odd elements of data structure S0 are associated with time window 2.

The data processing system 510 receives item data 520, similar to item data 420 previously described. Based on one or more values of the identifier, the data structure element selection logic 506 selects an element of data structure S0. In this example, element 4 is selected. The data processing system 510 accesses element 4 of data structure (hash ring) S0 of the data structure mapping logic 504. In this example, element 4 of the data structure S0 is populated with a location 118a of the set of locations 118. The data processing system 510 generates storage location data 522a indicating that the data item 108a is to be stored at location 118a of data storage system 220. The data processing system 510 can optionally store data item 108a at storage location 118a or instruct one or more devices (e.g., client device 112a) to store data item 108a at storage location 118a.

FIG. 5B is a diagram illustrating the computing system 500 determining a location for storing data item 108a based on a second time window (time window 2). The selection engine 502 executes the data structure element selection logic 506 to determine an element of the data structure S0 that is checked for a location for storing the data item 108a by the data structure mapping logic 504. The logic 506 selects element 5 from the available elements (odd elements associated with other sub data structure). Element 5 includes a pointer to location 120a of the second set of locations 120. The data processing system 510 generates storage location data 522b indicating that the data item 108a is to be stored at location 120a of the data storage system 220. The data processing system 510 provides the storage location 120a for storing the data item 108a.

As shown in FIGS. 5A-5B, the data item 108a is stored in at least two locations, 118a and 120a. Each location is in a different set 118, 120 of locations, respectively.

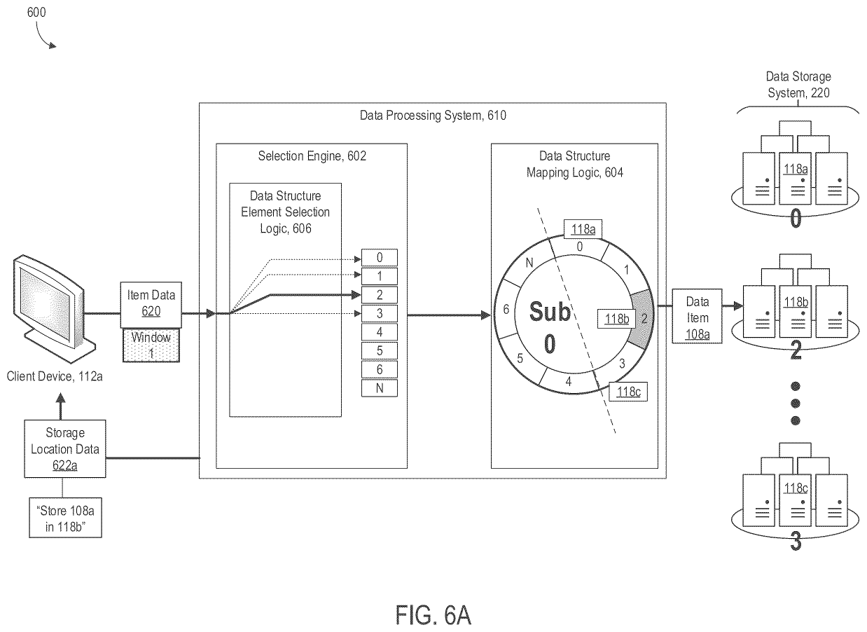

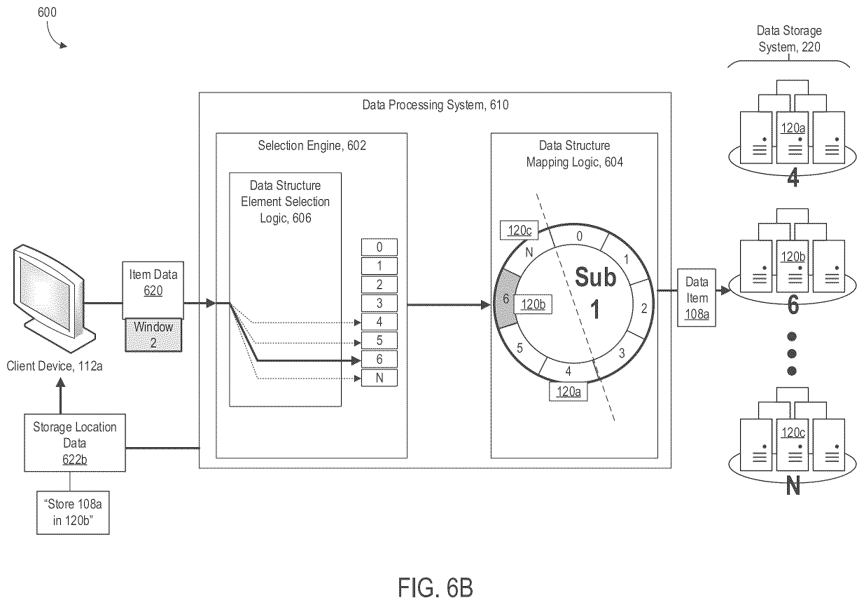

FIGS. 6A and 6B are diagrams illustrating a computing system 600 that uses a data structure that has sub-data structures (e.g., single ring with elements in first half representing a first sub-data structure and elements in a second half representing a second sub-data structure). FIG. 6A illustrates the determination of a first storage location for a data item using a data structure associated with a first time window and FIG. 6B illustrates the determination of a second storage location for the same data item using a data structure associated with a second time window. Computing system 600 includes a data processing system 610 for distributing data in a data storage system 220 using data structure S0 associated with a first time window. The computing system 600 can be similar to computing system 400, previously described in relation to FIGS. 4A-4B.

Referring to FIG. 6A, data processing system 610 includes a selection engine 602 configured to execute data structure element selection logic 606. The selection logic 606 for time window 1 is configured to select one of elements 0-3 of the data structure. These elements 0-3 correspond to a partition of the data structure that is called sub-data structure 0, or Sub0.

The data processing system 610 includes data structure mapping logic 604. The selection logic 606 selects an element 2 from the single data structure of the data structure mapping logic 604. The mapping logic 604 includes a single hash ring (e.g., a single data structure) that is partitioned in to sub-data structures Sub0 and Sub1. Each of the sub-data structures Sub0 and Sub1 of the hash ring S0 include elements that point to a set of locations that are absent from the set of locations of the other sub-data structure(s). For example, the data structure Sub0 includes a lower half of the elements (e.g., 0-3). The elements 0-3 of the first sub-data structure elements specify locations 118a-c of a first set 118 of locations of the data storage system 220. The second sub-data structure Sub1 includes the higher half of the elements (4. . . . N, where N is 7). The elements of sub-data structure Sub1 specify locations 120a-c of a second set 120 of locations of the data storage system 220 (e.g., as seen in FIG. 6B).

The data processing system 610 receives item data 620, similar to item data 420, 520 previously described. Based on one or more values of the item data, the data structure element selection logic 606 selects an element of data structure S0. In this example, element 2 is selected. The data processing system 610 accesses element 2 of data structure (hash ring) S0. In this example, element 2 of the data structure Sub0 is populated with a location 118b of the set of locations 118. The data processing system 610 generates storage location data 622a indicating that the data item 108a is to be stored at location 118b of the data storage system 220. The data processing system 610 provides the storage location 118b for storing data item 108a.

FIG. 6B is a diagram illustrating the computing system 600 of FIG. 6A including the data processing system 610. The data processing system 610 determines a location for storing data item 108a based on a second time window (time window 2). The selection engine 602 executes the data structure element selection logic 606 to determine an element of the data structure Sub1 that is checked for a location for storing the data item 108a by the data structure mapping logic 604. The logic 606 selects element 6 from the available elements (elements 4. . . . N). The element 6 is populated with a pointer to location 120b of the second set of locations 120. The data processing system 610 generates storage location data 622b indicating that the data item 108a is to be stored at location 120b of data storage system 220. Data processing system 610 can initiate a storage operation using storage location data 622b or can provide the storage location data 622b to one or more other devices so they can initiate the storage operation. As shown in FIGS. 6A-6B, the data item 108a is stored in at least two locations, 118b and 120b. Each location is from a different set 118, 120 of storage locations, respectively (e.g., from different sets of storage devices).

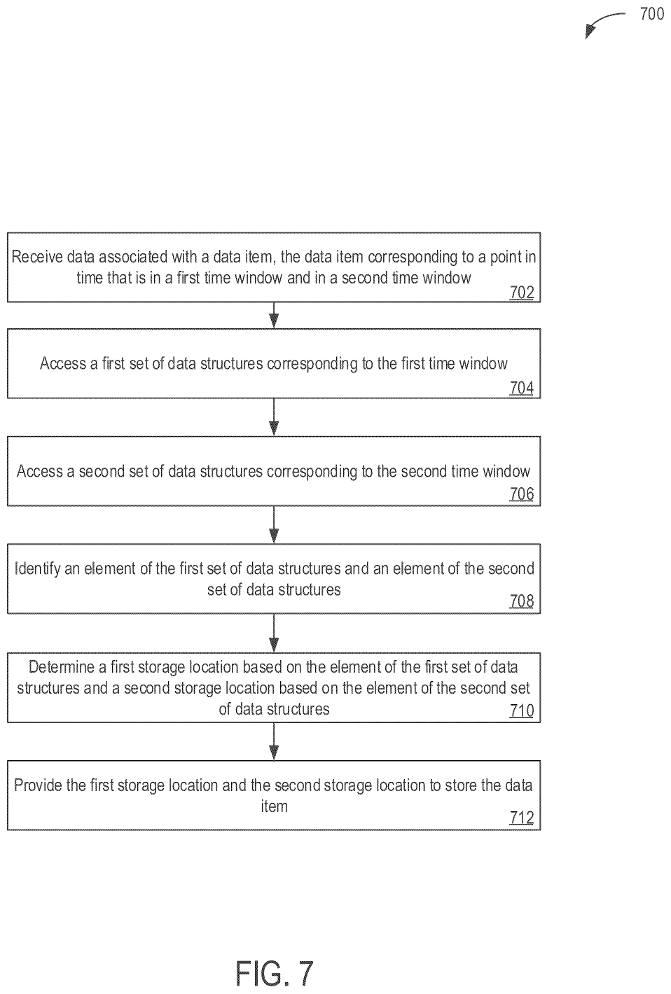

FIG. 7 is a flow diagram illustrating an example process for distributing the storage of data items across one or more data storage systems. The process 700 can be executed, for example, by the data processing system 102 described in relation to FIG. 1. The process 700 includes receiving (702), by the data processing system, data associated with a data item. The data item corresponds to a point in time that is in a first time window and in a second time window that partially overlap. The data (e.g., item data 420) associated with the data item can include metadata describing the data item, such as an organization identifier, a shard identifier, environment identifier, metric identifier, other value, or a combination thereof.

The process 700 includes accessing (704), by the data processing system, a first set of data structures corresponding to the first time window. The first set of data structures include a first data structure that maps to a first set of storage locations and a second data structure that maps to a second set of storage locations. A set of storage locations can include storage locations in one or more storage systems (e.g., file systems, databases) of the data storage system. The first data structure and the second data structure can each be a hash ring or other list of elements that are linked together and that can be traversed by the data processing system for accessing data associated with the elements. The data associated with an element can include a pointer or other data that identifies a storage location of the set of locations in the data storage system. The storage locations can each be servers or other hosts of data in a data center.

The process 700 includes accessing (706) a second set of data structures corresponding to the second time window. The second set includes a first data structure that maps to a set of storage locations that are absent all of the storage locations in the first set of storage locations. The second set also includes a second data structure that maps to a set of storage locations that are absent all of the storage locations in the second set of storage locations. Therefore, the set of locations for the first data structure of the first set of data structures (first time window) are mutually exclusive from the set of locations for the first data structure of the second set of data structures (second time window).

As previously described, a time window represents a period of time during which data items are identified for being stored. The first time window and the second time window are configured to at least partially overlap each other so that both the first time window and the second time window are active at a same point in time.

The process 700 includes using (708), by the data processing system, the data associated with the data item to identify an element of the first set of data structures and an element of the second set of data structures. In one example, the element for the first set and the element for the second set may be at different positions in the respective data structures (e.g., S1 element 5 and S1 element 9). In another example, the element for the first set and the element for the second set may be at the same position in their respective data structures (e.g., S1 element 5). The data processing system identifies at least two elements, but can identify additional elements of data structures for corresponding additional overlapping time windows, as previously described.

The process 700 includes determining (710), by the data processing system, a first storage location based on the element of the first set of data structures and a second storage location based on the element of the second set of data structures. The first location and the second location are each in respective sets of locations that are mutually exclusive of one another. In one example, if hardware hosts for one set of locations are unavailable, the data item is still available because it is stored in the second set of locations that are associated with different hardware hosts.

The process 700 includes providing (712), by the data processing system, the first storage location and the second storage location to store the data item. Providing the first or second storage location can include generating storage location data (e.g., pointer or resource locator) that specifies the first storage location or the second storage location to control a computing system (e.g., a data storage system manager) to store the data item at the specified location.

In an aspect, the first set of data structures and the second set of data structures each include a plurality of hash rings. The plurality of hash rings of the first set include data that maps a plurality of data items to a plurality of storage locations. Each of the plurality of data items is mapped to one of the plurality of storage locations.

In an aspect, the process 700 includes generating the first set of data structures for the first time window, the second set of data structures for the second time window, and a set of data structures for each subsequent time window. The first time window and the second time window are consecutive overlapping time windows (e.g., as described in relation to FIGS. 3A-3B).

In an aspect, the first data structure of the first set and the first data structure of the second set map to mutually exclusive sets of storage locations. The second data structure of the first set and the second data structure of the second set map to mutually exclusive sets of storage locations. In an example, there are exactly two data structures in each set, each specifying about half of the available locations for storing data items. In an aspect, the first and second sets of data structures each include two data structures. The first data structure of the first set and the second data structure of the second set map to a same set of storage locations. The second data structure of the first set and the first data structure of the second set map to a same set of storage locations.

In an aspect, using, by the data processing system, the data associated with the data item to identify the element of the first set of data structures includes a set of operations. The operations include performing a mathematical operation on a portion of the data to produce a first output value. The first output value indicates or identifies one of the data structures in the first set of data structures. In one example, the mathematical operation can include a modulo operation. The operations can also include performing a second mathematical operation (e.g., hash operation) on a portion of the data associated with the data item to produce a second output value (e.g., hash value or digest). The second output value is used to indicate or identify one of the elements in the identified data structure.

In an aspect, determining the first storage location based on the identified element includes traversing the first data structure of the first set of data structures for an element that includes a storage location. The traversal starts at the identified element that is absent a storage location and ends at an element that includes the first storage location. The traversal can be a form of searching and use one or more search techniques (e.g., binary search). The order of traversal of the elements can be based on a structure of the data structure. For example, the data processing system can traverse clockwise or anti-clockwise around a hash ring, traverse along a linked list, and so forth.

In an aspect, process 700 includes storing each of a plurality of incoming data items at a storage location determined using the first set of data structures and at a storage location determined using the second set of data structures.

In an aspect, the process 700 includes restarting a pool of storage devices that host the first and second sets of storage locations. Restarting the storage devices (hosts) can include restarting all of the storage hosts associated with the first data structure of the first set of data structures. The data processing system determines when all of the storage hosts associated with the first data structure are available. The data processing system restarts all of the storage hosts associated with the second data structure of the first set of data structures.

One or more aspects or embodiments of the methods and systems are described herein.

In a general aspect, a process comprises receiving data associated with a data item, the data item corresponding to a point in time that is in a first time window and in a second time window. The process comprises accessing a first set of data structures corresponding to the first time window, the first set of data structures comprising a first data structure that maps to a first set of storage locations and a second data structure that maps to a second set of storage locations. The process comprises accessing a second set of data structures corresponding to the second time window, the second set of data structures comprising a first data structure that maps to a set of storage locations that are absent the storage locations of the first set of storage locations and comprising a second data structure that maps to a set of storage locations that are absent the storage locations of the second set of storage locations. The process comprises using the data associated with the data item to identify an element of the first set of data structures and an element of the second set of data structures. The process comprises determining a first storage location based on the element of the first set of data structures and a second storage location based on the element of the second set of data structures. The process comprises providing the first storage location and the second storage location to store the data item.

In some implementations, the first set of data structures and the second set of data structures each comprise a plurality of hash rings, wherein the plurality of hash rings of the first set comprise data that maps a plurality of data items to a plurality of storage locations and each of the plurality of data items is mapped to one of the plurality of storage locations.

In some implementations, the process comprises generating the first set of data structures for the first time window, the second set of data structures for the second time window, and a set of data structures for each subsequent time window, wherein the first time window and the second time window are consecutive overlapping time windows.

In some implementations, the first data structure of the first set and the first data structure of the second set map to mutually exclusive sets of storage locations. The second data structure of the first set and the second data structure of the second set map to mutually exclusive sets of storage locations.

In some implementations, the first and second sets of data structures each include two data structures, wherein the first data structure of the first set and the second data structure of the second set map to a same set of storage locations. The first data structure of the second set and the second data structure of the first set map to a same set of storage locations.

In some implementations, using the data associated with the data item to identify the element of the first set of data structures comprises performing a first mathematical operation on a portion of the data to produce a first output value. The first output value identifies one data structure in the first set of data structures. In some implementations, using the data associated with the data item to identify the element of the first set of data structures comprises performing a second mathematical operation on a portion of the data to produce a second output value. The second output value identifies one element in the identified data structure.

In some implementations, the first mathematical operation comprises a modulo operation that is performed on the portion of the data to produce the first output value.

In some implementations, the second mathematical operation comprises a hash function that is configured for a uniform distribution of output values.

In some implementations, determining the first storage location based on the identified element comprises searching the first data structure of the first set of data structures for an element that comprises a storage location, wherein the searching starts at the identified element that is absent a storage location and ends at an element that comprises the first storage location.

In some implementations, the process comprises storing each of a plurality of incoming data items at a storage location determined using the first set of data structures and at a storage location determined using the second set of data structures.

In some implementations, the process comprises restarting a pool of storage devices that host the first and second sets of storage locations. In some implementations, the restarting comprises restarting all storage devices associated with the first data structure of the first set of data structures. In some implementations, the restarting comprises determining when all the storage devices associated with the first data structure are available. In some implementations, the restarting comprises restarting all storage devices associated with the second data structure of the first set of data structures in response to the determining.

In some implementations, the first set of data structures and the second set of data structures each comprise a single hash ring, and wherein the single hash ring comprises a first sub-data structure comprising odd elements and a second sub-data structure comprising even elements. The first sub-data structure represents the first data structure of the first set of data structures and the second sub-data structure represents the second data structure of the first set of data structures.

In some implementations, the process comprises accessing the data item from a data storage system by performing operations comprising: receiving metadata associated with a plurality of data items, the metadata indicating an organization identifier and a time within a time window; using the time window to identify the second set of data structures; using the metadata to identify the element of the second set of data structures; identifying, based on the element of the second set of data structures, a storage location; and receiving the plurality of data items from the identified storage location.

In some implementations, providing the first storage location and the second storage location to store the data item comprises initiating one or more storage operations that store the data item at the first storage location.

In a general aspect, a system comprises at least one processor and a memory storing instructions for execution by the at least one processor, the instructions, when executed by the at least one processor, causing the at least processor to perform the operations of the forgoing process.

In a general aspect, one or more non-transitory computer-readable media storing instructions that, when executed by one or more processing devices, cause the one or more processing devices to perform the operations of the foregoing process.

Some implementations of subject matter and operations described in this specification can be implemented in digital electronic circuitry, or in computer software, firmware, or hardware, including the structures disclosed in this specification and their structural equivalents, or in combinations of one or more of them. For example, in an aspect, the computing system 102, the client device 112, and the host system 114 can be implemented using digital electronic circuitry, or in computer software, firmware, or hardware, or in combinations of one or more of them. In another example, the process 700 can be implemented using digital electronic circuitry, or in computer software, firmware, or hardware, or in combinations of one or more of them.

Some implementations described in this specification (e.g., data processing systems 202, 410, 510, 610, etc.) can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

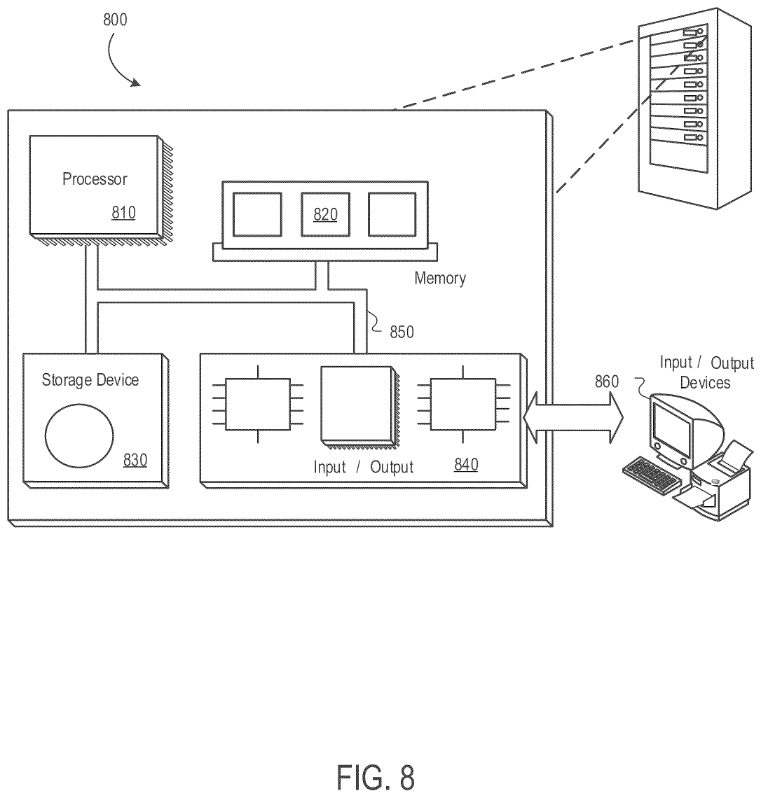

FIG. 8 shows an example computer system 800 that includes a processor 810, a memory 820, a storage device 830 and an input/output device 840. Each of the components 810, 820, 830 and 840 can be interconnected, for example, by a system bus 850. The processor 810 is capable of processing instructions for execution within the system 800. In an aspect, the processor 810 is a single-threaded processor, a multi-threaded processor, or another type of processor. The processor 810 is capable of processing instructions stored in the memory 820 or on the storage device 830. The memory 820 and the storage device 830 can store information within the system 800.

The input/output device 840 provides input/output operations for the system 800. In an aspect, the input/output device 840 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In an aspect, the input/output device can include driver devices configured to receive input data and send output data to other input/output devices, e.g., keyboard, printer and display devices 960. In an aspect, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the data processing system described herein. Accordingly, other embodiments are within the scope of the following claims.

What is claimed is:

1. A method comprising:
receiving data associated with a data item, the data item corresponding to a point in time that is in a first time window and in a second time window;
accessing a first set of data structures corresponding to the first time window, the first set of data structures comprising a first data structure that maps to a first set of storage locations and a second data structure that maps to a second set of storage locations;
accessing a second set of data structures corresponding to the second time window, the second set of data structures comprising a first data structure that maps to a set of storage locations that are absent the storage locations of the first set of storage locations and comprising a second data structure that maps to a set of storage locations that are absent the storage locations of the second set of storage locations;
using the data associated with the data item to identify an element of the first set of data structures and an element of the second set of data structures;
determining a first storage location based on the element of the first set of data structures and a second storage location based on the element of the second set of data structures; and
providing the first storage location and the second storage location to store the data item.

2. The method of claim 1, wherein the first set of data structures and the second set of data structures each comprise a plurality of hash rings, wherein the plurality of hash rings of the first set comprise data that maps a plurality of data items to a plurality of storage locations and each of the plurality of data items is mapped to one of the plurality of storage locations.

3. The method of claim 1, further comprising generating the first set of data structures for the first time window, the second set of data structures for the second time window, and a set of data structures for each subsequent time window, wherein the first time window and the second time window are consecutive overlapping time windows.

4. The method of claim 1, wherein the first data structure of the first set and the first data structure of the second set map to mutually exclusive sets of storage locations, and wherein the second data structure of the first set and the second data structure of the second set map to mutually exclusive sets of storage locations.

5. The method of claim 4, wherein the first and second sets of data structures each include two data structures, wherein the first data structure of the first set and the second data structure of the second set map to a same set of storage locations, and wherein the first data structure of the second set and the second data structure of the first set map to a same set of storage locations.

6. The method of claim 1, wherein the using the data associated with the data item to identify the element of the first set of data structures comprises:
performing a first mathematical operation on a portion of the data to produce a first output value, wherein the first output value identifies one data structure in the first set of data structures; and
performing a second mathematical operation on a portion of the data to produce a second output value, wherein the second output value identifies one element in the identified data structure.

7. The method of claim 6, wherein the first mathematical operation comprises a modulo operation that is performed on the portion of the data to produce the first output value.

8. The method of claim 6, wherein the second mathematical operation comprises a hash function that is configured for a uniform distribution of output values.

9. The method of claim 1, wherein the determining the first storage location based on the identified element comprises searching the first data structure of the first set of data structures for an element that comprises a storage location, wherein the searching starts at the identified element that is absent a storage location and ends at an element that comprises the first storage location.

10. The method of claim 1, further comprising storing each of a plurality of incoming data items at a storage location determined using the first set of data structures and at a storage location determined using the second set of data structures.

11. The method of claim 1, further comprising restarting a pool of storage devices that host the first and second sets of storage locations, wherein the restarting comprises:
restarting all storage devices associated with the first data structure of the first set of data structures;
determining when all the storage devices associated with the first data structure are available; and
restarting all storage devices associated with the second data structure of the first set of data structures in response to the determining.

12. The method of claim 1, wherein the first set of data structures and the second set of data structures each comprise a single hash ring, and wherein the single hash ring comprises a first sub-data structure comprising odd elements and a second sub-data structure comprising even elements, wherein the first sub-data structure represents the first data structure of the first set of data structures and the second sub-data structure represents the second data structure of the first set of data structures.

13. The method of claim 1, further comprising accessing the data item from a data storage system by performing operations comprising:
receiving metadata associated with a plurality of data items, the metadata indicating an organization identifier and a time within a time window;
using the time window to identify the second set of data structures;
using the metadata to identify the element of the second set of data structures;
identifying, based on the element of the second set of data structures, a storage location; and
receiving the plurality of data items from the identified storage location.

14. The method of claim 1, wherein providing the first storage location and the second storage location to store the data item comprises initiating one or more storage operations that store the data item at the first storage location.

15. A system comprising:
at least one processor; and
a memory storing instructions for execution by the at least one processor, the instructions, when executed by the at least one processor, causing the at least processor to perform operations comprising:
receiving data associated with a data item, the data item corresponding to a point in time that is in a first time window and in a second time window;
accessing a first set of data structures corresponding to the first time window, the first set of data structures comprising a first data structure that maps to a first set of storage locations and a second data structure that maps to a second set of storage locations;
accessing a second set of data structures corresponding to the second time window, the second set of data structures comprising a first data structure that maps to a set of storage locations that are absent the storage locations of the first set of storage locations and comprising a second data structure that maps to a set of storage locations that are absent the storage locations of the second set of storage locations;
using the data associated with the data item to identify an element of the first set of data structures and an element of the second set of data structures;
determining a first storage location based on the element of the first set of data structures and a second storage location based on the element of the second set of data structures; and
providing the first storage location and the second storage location to store the data item.

16. The system of claim 15, wherein the first set of data structures and the second set of data structures each comprise a plurality of hash rings, wherein the plurality of hash rings of the first set comprise data that maps a plurality of data items to a plurality of storage locations and each of the plurality of data items is mapped to one of the plurality of storage locations.

17. The system of claim 15, the operations further comprising generating the first set of data structures for the first time window, the second set of data structures for the second time window, and a set of data structures for each subsequent time window, wherein the first time window and the second time window are consecutive overlapping time windows.

18. The system of claim 15, wherein the first data structure of the first set and the first data structure of the second set map to mutually exclusive sets of storage locations, and wherein the second data structure of the first set and the second data structure of the second set map to mutually exclusive sets of storage locations.

19. The system of claim 15, the operations further comprising restarting a pool of storage devices that host the first and second sets of storage locations, wherein the restarting comprises:
restarting all storage devices associated with the first data structure of the first set of data structures;
determining when all the storage devices associated with the first data structure are available; and
restarting all storage devices associated with the second data structure of the first set of data structures in response to the determining.

20. One or more non-transitory computer-readable media storing instructions that, when executed by one or more processing devices, cause the one or more processing devices to perform operations comprising:
receiving data comprising an index value associated with a data item, the index value identifying the data item, the data comprising the index value being received during a first time window and during a second time window that at least partially overlaps in time with the first time window;
accessing a first set of hash rings corresponding to the first time window, a first hash ring of the first set of hash rings comprising first elements that specify first storage locations, and a second hash ring of the first set of hash rings comprising second elements that specify second storage locations;
accessing a second set of hash rings corresponding to the second time window, a first hash ring of the second set of hash rings comprising first elements that specify the second storage locations, and a second hash ring of the second set of hash rings comprising second elements specifying the first storage locations;
wherein the first locations form a first set of locations that is absent any of the second locations;
wherein the second locations form a second set of locations that is absent any of the first locations;
identifying, as a function of the index value, a first element of the first hash ring of the first set of hash rings that specifies a first storage location, the specifying based on a first hash function,
identifying, as a function of the index value, a first element of the first hash ring of the second set of hash rings that specifies a second storage location, the specifying based on a second hash function;
determining the first storage location and the second storage location; and
generating an instruction for causing storage of the data item in the first storage location and in the second storage location.
